(19) United States
(12) Patent Application Publication
(10) Pub. No.: US 2007/0004861 A1
(43) Pub. Date: Jan. 4, 2007

(54) High melt strength polypropylene resins and method for making same

(76) Inventors: Kevin Cai, Arlington, TX (US); Anthony Nguyen, Arlington, TX (US)

Correspondence Address: WINSTON & STRAWN LLP;PATENT DEPARTMENT, 1700 K STREET, N.W., WASHINGTON, DC, 20006, US

(21) Appl. No.: 11/171,546

(22) Filed: Jul. 1, 2005

(51) Int. Cl. C08F 8/00

(52) U.S. Cl. 525/192

(57) ABSTRACT

The melt strength of an unmodified semi-crystalline polypropylene resin may be increased via thermally reversible ionic bonds and long chain branches formed by the addition of a sufficient amount of at least one peroxygenated polyolefin and a sufficient amount of at least one metallic coupling agent. The peroxide content of the peroxygenated polyolefin ranges from about 1 mmol to 200 mmol total peroxide per kilogram of polymer. The metallic coupling agent is typically at least one metallic salt of alpha, beta-unsaturated carboxylic acids or alpha, beta-unsaturated carboxylic acids where the acid group has been neutralized.

### TECHNICAL FIELD

This invention relates generally to modified semi-crystalline polypropylene resins wherein the melt strength of the unmodified polypropylene resin is enhanced by the addition of a sufficient amount of at least one peroxygenated polyolefin and of a sufficient amount of at least one metallic coupling agent. Also included are compositions containing such modified polypropylene resins, molded or extruded articles formed using such modified polypropylene resins, as well as methods for producing compositions and articles using the same.

### BACKGROUND OF THE INVENTION

Commercial grades of isotactic or syndiotactic polypropylene demonstrate a deficiency in melt strength due to the essentially linear nature of the polymer and subsequent absence of long chain branching. Such polypropylene resins have therefore been underutilized in applications requiring increased melt strength (e.g., extrusion coating, blow molding, foam extrusion, profile extrusion, and thermoforming). The low melt strength of polypropylene has typically been increased by one of the known methods: (1) addition of branched polymers to the blend; (2) post-reactor long chain branching through reactive processes involving organic peroxides; or (3) post-reactor irradiation.

U.S. Pat. No. 5,047,485, for example, discloses a process for producing a propylene polymer with free-end long chain branching by mixing a low-decomposition-temperature peroxide with a linear propylene polymer in the substantial absence of atmospheric oxygen, heating the resulting mixture to 120° C., and then deactivating substantially all the free radicals present in the propylene polymer. The processing temperature must be sufficient to decompose the low decomposition temperature peroxide but low enough to favor the recombination of the polymer fragments. It is further taught that processing temperatures above 120° C. provide a product with little or no branching (i.e., an essentially linear polymer).

U.S. Pat. No. 5,541,236 discloses a solid-state process for making a high melt strength propylene polymer by the formation of free-end long branches through irradiating linear propylene polymer material in a substantially oxygen-free environment (less than about 15% oxygen by volume) with high energy radiation to produce a substantial amount of molecular chain scission, maintaining the irradiated propylene polymer in the substantially oxygen-free environment to allow chain branches to form, and then deactivating substantially all the free radicals present in the irradiated propylene polymer material.

In the presence of free radicals formed from irradiation or peroxide reaction at higher temperatures, however, branching and chain scission (i.e., fragmentation) of polypropylene occur simultaneously, with chain scission mechanisms dominating due to first order kinetics. In contrast, the effect of free radicals in the presence of polyethylene leads to crosslinking by macroradical recombination (i.e., covalent bonds may be formed that link the crystalline and amorphous regions of polyethylene into a three-dimensional network). A peroxide-initiated degradation of polypropylene may be used for production of controlled rheology resins with tailor-made properties: narrowed molecular weight distribution, lowered weight average molecular weight, and increased melt flow rate, as described, for example, in U.S. Pat. No. 4,451,589. The degradation, or visbreaking, of polypropylene as described therein results in an undesirable lowering of melt strength for the polymer (i.e., chain scission results in lower molecular weight and higher melt flow rate polypropylenes than would be observed were the branching not accompanied by scission).

In general, reactive processing, as opposed to simple melt blending, is an efficient means for the continuous polymerization of monomers and for the chemical modification of existing polymers (e.g., controlled degradation, chain extension, branching, grafting, and modification of functional groups) in the absence of solvents. To chemically modify a polypropylene with reactive processing, by way of example a graft copolymer may be made by forming active grafting sites on the propylene polymer backbone by treatment with a peroxide or other chemical compound that is a free radical polymerization initiator. The free radicals produced on the polymer as a result of the chemical treatment initiate the attachment of a reactive monomer, such as a polar group, at these sites. Polypropylenes chemically modified with a polar group show an improved adhesion to metals and may be used as a compatibilizer in immiscible blends.

U.S. Pat. No. 3,970,722, for example, discloses a method for preparing a modified polypropylene as a bonding agent by mixing crystalline propylene polymer, 0.1 to 5% organic peroxide with a half-life of one minute, and 0.1 to 7% modifying agent. The modifying agent may be either: (1) acrylic and methacrylic salts of Na, Ca, Mg, Zn, Al and Fe(III) or (2) compounds containing a phenol or benzyl group (e.g., 4-methacryloyl-oxymethylphenol). Because an excessive amount of organic peroxide may result in an increased melt flow index for the modified propylene polymer, it is taught that a non-modified crystalline propylene polymer in an amount of 50% or less may be added to the modified mixture in order to reduce the melt flow index to 120 or less. Also disclosed is that the organic peroxide should decompose completely during the preparation of the modified propylene polymer to prevent the decomposition of the non-modified crystalline propylene polymer added after modification.

An alternative method for introducing functional groups onto the polymer is described in U.S. Pat. No. 5,447,985. This process involves the addition of a peroxide (e.g., t-butylperoxy maleic acid) having an activated unsaturation within the peroxide molecule and the optional addition of a coagent (e.g., triallyl cyanurate, triallyl isocyanurate, ethylene glycol dimethacrylate, and trimethylolpropane trimethacrylate). The patent teaches that the activating group in the peroxide is a carboxylic acid group and that the melt flow index of the (co)polymer is significantly increased by the peroxide modification.

Grafting low molecular weight side chains onto peroxygenated polyolefins is known in the prior art. U.S. Pat. No. 6,444,722 discloses a process for making graft copolymers by treating the peroxygenated polyolefin in a substantially non-oxidizing atmosphere at a temperature of about 110° to 140° C. with at least one grafting monomer in liquid form and at least one additive to control the molecular weight of the side chains. It is disclosed that there is a need to control the molecular weight of the polymerized monomer side chains of polypropylene graft copolymers made from the peroxygenated polyolefin so that low molecular weight side chains are produced without adversely affecting the overall physical properties of the graft copolymer.

Grafting short chain branches or functional groups onto semicrystalline polypropylene resins, however, has proven to be insufficient to enhance the melt strength of such resins. Poor melt strength of polypropylenes can be seen in properties such as, e.g., excess sag in sheet extrusion, rapid thinning of walls in parts thermoformed in the melt phase, low draw-down ratios in extrusion coating, poor bubble formation in extrusion foam materials, and relative weakness in large-part blow molding. In addition, the use of free radical generators, such as organic peroxides, having a highly concentrated peroxide content (i.e., greater than 400 mmoles/kg) must be carefully controlled in order to keep the degradation (e.g., increased melt flow rate) of the polypropylene resin to a minimum. Accurately metering such low levels of peroxide in grafted propylene production is very difficult even when an organic peroxide masterbatch with low peroxide content is used.

Despite the variety of prior art materials and techniques, there remains a need for semi-crystalline polypropylene resins with high melt strength, articles containing the same, and methods for producing such resins and articles, which can now be achieved with the present invention.

### SUMMARY OF THE INVENTION

The invention relates to reactively blended propylene compositions including the following or a reaction product thereof: a base polymer comprising at least one semi-crystalline polypropylene resin component, at least one peroxygenated polyolefin component present in an amount greater than 0.05 pph, and at least one metallic coupling agent present in an amount which, in combination with the peroxygenated component, is sufficient to provide increased melt strength to the reactively blended propylene composition compared to the semi-crystalline resin component.

In preferred embodiments, the peroxygenated polyolefin component has a peroxide content ranging from about 1 mmol to 200 mmol total peroxide per kilogram of polyolefin, and the sufficient amount of metallic coupling agent is from about 0.01 to 7 pph of the base polymer. The metallic coupling agent typically includes metal salts of alpha, beta-unsaturated carboxylic acids, or alpha, beta-unsaturated carboxylic acids where the acid group has been neutralized, or mixtures thereof. The alpha, beta-unsaturated carboxylic acids of the metallic coupling agent include acrylic, methacrylic, maleic, fumaric, ethacrylic, vinyl-acrylic, itaconic, methyl itaconic, aconitic, methyl aconitic, crotonic, alpha-methylcrotonic, cinnamic, or 2,4-dihydroxy cinnamic acids, or mixtures thereof. The metals for forming the metal salts of the metallic coupling agent include zinc, lithium, calcium, magnesium, sodium, or aluminum, or mixtures thereof. The base polymer may further include one or more olefinic elastomers, styrenic elastomers, or a mixture thereof. One or more thermal stabilizers, ultraviolet stabilizers, flame retardants, mineral fillers, extender or process oils, conductive fillers, nucleating agents, plasticizers, impact modifiers, colorants, mold release agents, lubricants, antistatic agents, or pigments, or combinations thereof may also be included.

Also encompassed are molded or extruded articles including the reactively blended propylene compositions.

The invention also relates to methods for producing a reactively modified propylene composition by blending a base polymer comprising at least one semi-crystalline polypropylene resin component with at least one peroxygenated polyolefin component present in an amount greater than 0.05 pph, and a sufficient amount of at least one metallic coupling agent to increase the melt strength of the reactively blended propylene composition to form a reaction blend, and reactively modifying the reaction blend to form the reactively modified propylene composition to increase the melt strength of the modified composition compared to the semi-crystalline resin component. The above embodiments describing the composition are equally applicable to the method aspect of the invention. For example, in one embodiment the alpha, beta-unsaturated carboxylic acid is neutralized by a metal ion that includes zinc, lithium, calcium, magnesium, sodium, aluminum, or a mixture thereof.

The invention also encompasses a method of increasing the melt strength of a base polymer comprising a semi-crystalline propylene composition by combining a sufficient amount of a peroxygenated polyolefin component and a sufficient amount of a metallic coupling agent with a semi-crystalline propylene composition to form a reaction blend, and reacting the reaction blend to form a semi-crystalline propylene composition having long chain branches and a melt strength that is increased compared to the melt strength of the semi-crystalline propylene composition before reaction.

### DETAILED DESCRIPTION OF THE PREFERRED EMBODIMENTS

It has now been discovered that inclusion of a peroxygenated polyolefin material with a semi-crystalline polyolefin, such as polypropylene, and coupled with a sufficient amount of a suitable metallic coupling agent can increase the melt strength in the resultant polymer blend. Typically, such reactive blending (also known as reactive extrusion, reactive processing, or reactive compounding) carries out chemical reactions in the bulk phase (i.e., without the use of diluents or solvents) via an interaction with free radical generators (e.g., peroxide) to produce specialty polymer blends through chemical modification of existing polymers. Preferably, the reactively blended propylene composition of the present invention demonstrates increased melt strength while avoiding or minimizing undesirable modifications such as a substantial increase in melt flow index or the substantial degradation (e.g., visbreaking) of polypropylene such as through scission, or the like.

In a preferred embodiment, the peroxygenated polyolefin is combined with the semi-crystalline polypropylene resin via grafting, which can be accomplished by any suitable method available to those of ordinary skill in the art. Without being bound by theory, the peroxygenated polyolefin is believed to serve a dual purpose: 1) as the source of free radicals for the reactive process forming the long chain branches onto the semi-crystalline polypropylene resin; and 2) as the potential starting point for the long chain branches (i.e., the polyolefin backbone portion of the peroxygenated polyolefin) to provide high melt strength for the resultant reactively blended propylene composition.

Branched polypropylene manufactured through covalent bonding alone, however, may suffer from a tendency of the branches to degrade due to the effect of shear inherent in the processing. Increasing the melt strength of polyolefins by grafting monomers that contain acid groups with thermally reversible ionic bonds onto the polyolefin is described in U.S. Pat. No. 6,586,532, which is hereby incorporated by express reference thereto. The graftable monomer bears at least one functional group chosen from a carbonyl and an acid anhydride. Neutralizing the acid group with sodium hydroxide or zinc acetate is stated to result in a polyolefin with increased melt strength while still retaining suitable thermoplastic characteristics. Without being bound by theory, it is believed that the metallic coupling agent used in the present invention serves a dual purpose in that it: 1) increases branching efficiency by minimizing unwanted side reactions, such as chain scission, on the semi-crystalline polypropylene resin; and 2) provides a thermally reversible ionic linkage between the semi-crystalline polypropylene resin and the long chain branches.

Without being bound by theory, it is believed that the combination of thermally reversible ionic bonds and long chain branches in the reactively blended propylene composition of the present invention results in an intermolecular ionic interaction between the semi-crystalline polypropylene resin and the polyolefin backbone portion of the peroxygenated polyolefin wherein the metallic coupling agent serves as a polymeric bridging element between some or all of the linear polymers composed of the semi-crystalline polypropylene resin and the long chain branches formed by the peroxygenated polyolefin. In this way, if any of the ionic bonds present in the reactively modified semi-crystalline polypropylene resin between the linear polymer and the long chain branches degrade during processing, the bonds may be reformed after cooling of the melt and absence of shear stress.

In one embodiment, reactive processes form long chain branches on the reactively modified semi-crystalline polypropylene resin component of the base polymer, detected by an increase in melt strength of the modified semi-crystalline polypropylene resin compared to the melt strength of the unmodified semi-crystalline polypropylene resin, by the addition to the unmodified semi-crystalline polypropylene resin component of a sufficient amount of at least one peroxygenated polyolefin component. In one preferred embodiment, the peroxygenated polyolefin component is present in an amount of greater than 0.05 to about 20 parts per hundred (pph) by total weight of the base polymer (e.g., the semi-crystalline propylene resin and the optional elastomer discussed herein) and the metallic coupling agent component is present in an amount of about 0.01 pph to 7 pph of the base polymer. It should be understood that all references to “pph” herein relate to the total weight of the base polymer unless otherwise noted.

The presence of a sufficient amount of at least one metallic coupling agent component preferably minimizes the degradation of the reactively modified semi-crystalline polypropylene resin component through the formation of thermally reversible ionic bonds between the modified semi-crystalline polypropylene resin and the long chain branches derived from the polymeric backbone portion of the peroxygenated polyolefin component. In a preferred embodiment, the metallic coupling agent component is present in an amount of about 0.01 pph to 7 pph of the base polymer.

Peroxide is classified as a compound that contains at least one pair of oxygen atoms bonded by a single covalent bond. “Organic peroxides” and “organic hydroperoxides” are defined herein as low weight average molecular weight (i.e., Mw<1,000) compounds having a definite number of reactive —OO— groups with a peroxide content greater than about 400 mmoles/kg. Inorganic peroxides, percarbonates and perborates, including sodium percarbonate (2Na₂CO₃.3H₂O₂), sodium perborate monohydrate (NaBO₃.H₂O), calcium peroxide (CaO₂), and magnesium peroxide (MgO₂), are solid (non-volatile) peroxides that are typically more stable than organic peroxides. Multifunctional peroxides, having the peroxide functionality located in the polymer backbone chain, are generally synthesized from vinyl, divinyl, carboxylic, or diene compounds. “Peroxygenated polyolefins” are defined herein as C₁ to C₈ alpha-olefin homopolymers or copolymers, or a combination thereof, with multiple peroxy bonds randomly distributed as pendant groups along the main polymer chain, a low concentration of peroxide groups (i.e., less than about 200 mmoles/kg), and a weight average molecular weight (Mw) greater than about 1,500, preferably greater than about 2,500, and more preferably greater than about 4,000. Preferably, the peroxygenated polyolefins are polypropylene or polyethylene, or a combination thereof.

The term “melt strength” refers to the maximum force attained before significant draw resonance or breakage occurs when pulling strands of molten polymers at constant acceleration until draw resonance or breakage occurred. The velocity at which draw resonance or breakage occurs is defined as the “melt extensibility” of a polymer blend. The term “high melt strength” is herein defined as a measurement of at least about 5 centi-Newtons (cN) at 230° C. An increase in melt strength is typically observed when long chain branches or similar structures are introduced into a polymer according to the invention.

The increase in melt strength is desired across a broad range of temperatures, which translates into an increased processing window of the resultant polymer blend. As used herein, “processing window” refers to the ranges of processing conditions, such as melt temperature, melt strength, pressure and shear rate, within which a specific plastic can be fabricated with acceptable or optimum properties by a particular fabrication process. The term “long chain branching” or “long chain branches” as defined herein refers to a polymer chain length of greater than about 50 carbon atoms. The side chains forming the long chain branches on the polymer backbone typically have a weight average molecular weight greater than about 1,000. The reactively blended polypropylene composition with long chain branches of the present invention demonstrates a two-dimensional structure in contrast with the three-dimensional structure of crosslinked polyethylene. As known to those skilled in the art, crosslinked polypropylene is virtually unknown due to its tertiary carbon.

The semi-crystalline polypropylene resin component is present in amounts of about 1 to 99 weight percent, preferably from about 2 to 80 weight percent, and more preferably from about 3 to 55 weight percent and is typically chosen from one or more of homopolymers of propylene, copolymers of at least 50 weight percent propylene and at least one other C₂ to C₂₀ alpha-olefin, or mixtures thereof. “Semi-crystalline,” as used herein, typically means that the crystallinity is at least about 30%, preferably at least about 50%, and more preferably at least about 80%. Moreover, the semi-crystalline polypropylene resin has a typical melt flow rate (as determined by ASTM D-1238-01 at a temperature of 230° C. and at a load of 2.16 kg) of about 0.001 dg/min to 500 dg/min, preferably about 0.01 to 250 dg/min, and more preferably about 0.1 to 150 dg/min. The semicrystalline propylene-based resin may be isotactic or syndiotactic, with a stereoregularity of at least about 80%, preferably at least about 90%. The propylene-based resin, with a melting point of about 162° C., may be grafted or ungrafted. In one embodiment, the propylene-based resin is at least substantially, or entirely, free of grafted functional groups.

The copolymer of propylene, if used, may preferably include a random copolymer or an impact block copolymer. Preferred alpha-olefins for such copolymers include ethylene, 1-butene, 1-pentene, 1-hexene, methyl-1-butenes, methyl-1-pentenes, 1-octene, 1-decene, or combinations thereof. If any such copolymer or mixture is employed, it is preferable to use one having an alpha-olefin content of about 1 to 45 percent by weight. In one embodiment, the alpha-olefin content can be about 10 to 30 percent by weight.

The impact block copolymers may include distinct blocks of variable composition; each block including a homopolymer of propylene and at least one other of the above-mentioned alpha-olefins. Although any suitable copolymerization method is included within the scope of the invention, copolymers with propylene blocks are generally obtained by polymerization in a number of consecutive stages in which the different blocks are prepared successively, as described in U.S. Pat. No. 3,318,976, which is hereby incorporated by express reference thereto. The order in which the different block components are polymerized is generally not critical. The alpha-olefin block component, when present, is distinct and different from the optional, but preferred ethylene-based elastomer component described below. In typical processes of this kind, propylene homopolymer is formed in one stage and the copolymer is formed in a separate stage, in the presence of the homopolymer and of the original catalyst. Multiple stage processes of this type are also known, and any suitable type can be used in accordance with the present invention.

For the catalyst for producing the impact block copolymer, although any suitable catalyst can be used it is preferred to employ a catalyst for producing a highly stereospecific polypropylene formed from:
(a) a solid catalyst component based on titanium containing magnesium, a halogen and an electron donor, such as Ziegler-Natta catalysts,
(b) a catalyst component based on organometallic compound(s), such as metallocene, constrained geometry, and late transition metal catalysts, and
(c) a catalyst component based on organosilisic compound(s) having at least one group selected from the group consisting of cyclopentyl, cyclopentenyl, cyclopentadienyl, and derivatives thereof.

The polymerization in each stage may be realized either continuously or in a batchwise or a semicontinuous process, though a continuous process is preferred. The polymerization may be performed by any suitable method, such as by known methods that include, for example, a gas phase polymerization or a liquid phase polymerization, such as solution polymerization, a slurry polymerization, or a bulk polymerization. The polymerizations in the second and the subsequent stages may preferably be carried out after to the first stage polymerization in a continuous manner. When a batch process is employed, the multistage polymerization can be effected in a single reactor. Products of such sequential polymerization processes may be referred to as “block copolymers,” but it should be understood that such products may also include intimate blends of, e.g., semi-crystalline polypropylene and propylene/alpha-olefin elastomer or other copolymers.

Exemplary semi-crystalline polypropylene homopolymers or copolymers according to the invention includes those that are commercially available as, for example, PROFAX, ADFLEX or HIFAX from Basell North America, Inc. of Wilmington, Del., as FORTILENE, ACCTUFF, or ACCPRO from British Petroleum Chemicals of Houston, Tex., and as various types of polypropylene homopolymers and copolymers from ExxonMobil Chemicals Company of Houston, Tex., from Borealis A/S from Lydgby, Denmark, from Sunoco Chemicals of Pittsburgh, Pa., and from Dow Chemical Company of Midland, Mich.

The peroxygenated polyolefin component is typically present in amounts of at least 0.05 pph, preferably from about 0.055 pph to 20 pph, more preferably from about 0.060 pph to 20 pph. In preferred embodiments, the peroxygenated polyolefin component is typically present in amounts of about 0.075 pph to 20 pph or greater than 0.075 pph to about 20 pph, and more preferably from about 0.1 pph to 15 pph. In one embodiment, the peroxygenated polyolefin component is present in an amount of from 0.15 pph to 5 pph. Preferably, the starting material for making the peroxygenated polyolefin component is typically chosen from one or more homopolymers of propylene, copolymers of at least 50 weight percent propylene and at least one other C₂ to C₂₀ alpha-olefin, one or more homopolymers of ethylene, copolymers of at least 20 weight percent ethylene and at least one other C₂ to C₂₀ alpha-olefin, or mixtures thereof. More preferably, the starting material for the peroxygenated polyolefin is a propylene homopolymer having an isotactic index greater than about 80%.

Peroxy linkages are generally attached randomly along the propylene backbone, resulting in a polymer with a peroxide content of about 1 to 200 mmoles per kilogram of polymer. The peroxy linkages distinguish the peroxygenated polyolefin from oxidized polypropylene wax, which typically has no detectable peroxide content or is at least substantially free of peroxide content. In contrast to the measurable peroxide content of a peroxygenated polyolefin, oxidized polypropylene wax is defined by its acid number, denoting the number of milligrams of potassium hydroxide required to saturate the free carboxylic acids contained in 1 gram of wax. The total peroxide content may be analyzed using standard methods such as two stage iodometric titration or direct titration with potassium permanganate.

The peroxide pendant groups of the peroxygenated polyolefin component may degrade, however, during compounding to form nonperoxide groups (e.g., acids, ketones and esters). In addition, the number average and weight average molecular weight of the peroxygenated polyolefin material is usually much lower than that of the corresponding olefin polymer used to prepare the same, due to the chain scission reactions during processing (i.e., irradiation and oxidation).

One method of preparing peroxygenated polyolefin material is well known to those of ordinary skill in the art and is described in, for example, U.S. Pat. Nos. 5,820,981 and 6,677,395, which are hereby incorporated herein by express reference thereto. Using this method, the olefin polymer starting material for the peroxygenated polyolefin material is exposed to high-energy ionizing radiation under a blanket of inert gas, preferably nitrogen. The ionizing radiation should have sufficient energy to penetrate the mass of polymer material being irradiated to the extent desired. The ionizing radiation can be of any kind, but preferably includes electrons and gamma rays. Satisfactory results are obtained at a dose of ionizing radiation of about 0.1 to about 15 megarads (“Mrad”). The term “rad” is usually defined as that quantity of ionizing radiation that results in the absorption of 100 ergs of energy per gram of irradiated material, regardless of the source of the radiation.

The free-radical containing irradiated olefin polymer material is then subjected to a series of oxidative treatment steps. The first treatment step consists of heating the irradiated polymer in the presence of a first controlled amount of oxygen greater than about 0.004% by volume but less than about 15% by volume, preferably from about 1.3% to about 3% by volume, to a first temperature of at least 25° C. but below the softening point of the polymer, preferably about 25° C. to 140° C., and more preferably to about 40° C. to 80° C. Heating to the desired temperature is accomplished as quickly as possible, preferably in less than about 10 minutes. The polymer is then held at the selected temperature, typically for about 5 to 90 minutes, to increase the extent of reaction of the oxygen with the free radicals in the polymer. The holding time, which can be determined by one of ordinary skill in the art, depends upon factors such as the properties of the starting material, the oxygen concentration used, the irradiation dose, and the temperature. The maximum time is determined by the physical constraints of the fluid bed.

In the second treatment step to obtain a peroxygenated polyolefin component, the irradiated polymer is heated in the presence of a second controlled amount of oxygen greater than about 0.004% by volume but less than about 15% by volume, preferably from about 1.3% to 3% by volume to a second temperature of at least about 25° C., but below the softening point of the polymer. Preferably, the second temperature is from about 80° C. to less than the softening point of the polymer, and greater than the first temperature of the first step. The polymer is then held at the selected temperature and oxygen concentration conditions, typically for about 90 minutes, to increase the rate of chain scission and to minimize the recombination of chain fragments so as to form long chain branches, i.e., to minimize the formation of long chain branches. The holding time is determined by the same factors discussed in relation to the first treatment step.

In the optional third step, the peroxygenated polyolefin material is heated under a blanket of inert gas, preferably nitrogen, to a third temperature of at least about 80° C., but below the softening point of the polymer, and held at that temperature for about 10 minutes to about 120 minutes, preferably about 60 minutes. A more stable product is typically produced if this step is carried out. It is preferred to use this step if the peroxygenated polyolefin material is going to be stored rather than used immediately, or if the radiation dose that is used is on the high end of the range described above. The polymer is then cooled to a fourth temperature of about 50° C. over a period of about 10 minutes under a blanket of inert gas, preferably nitrogen, before being discharged from the bed. In this manner, stable intermediates are formed that can be stored at room temperature for long periods of time without further degradation.

In addition to the above noted method of providing peroxygenated polyolefin materials, a preferred method of making the peroxygenated polyolefin material is to carry out the treatment by passing the irradiated polymer through a fluid bed assembly operating at a first temperature in the presence of a first controlled amount of oxygen, passing the polymer through a second fluid bed assembly operating at a second temperature in the presence of a second controlled amount of oxygen, and then maintaining the polymer at a third temperature under a blanket of nitrogen, in a third fluid bed assembly. In commercial operation, a continuous process using separate fluid beds for the first two steps, and a purged, mixed bed for the third step is preferred. The process can also be carried out, however, in a batch mode in one fluid bed, using a fluidizing gas stream heated to the desired temperature for each treatment step. Unlike some techniques, such as melt extrusion methods, the fluidized bed method does not require the conversion of the irradiated polymer into the molten state and subsequent re-solidification and comminution into the desired form. The fluidizing medium can be, for example, nitrogen or any other gas that is inert with respect to the free radicals present, e.g., argon, krypton, and helium.

The concentration of peroxide groups formed on the polymer can be readily controlled by varying the radiation dose during the preparation of the irradiated polymer and the amount of oxygen to which such polymer is exposed after irradiation. The oxygen level in the fluid bed gas stream is preferably controlled by the addition of dried, filtered air at the inlet to the fluid bed. It is typically desired to constantly add air to compensate for the oxygen consumed by the formation of peroxides in the polymer.

Alternatively, the peroxygenated polyolefin material could be prepared according to the following procedures or any other suitable method(s). In the first treatment step, the olefin polymer starting material is treated with about 0.1 weight percent to 10 weight percent of an organic peroxide initiator while adding a controlled amount of oxygen so that the olefin polymer material is exposed to greater than about 0.004% but less than about 21% by volume, at a temperature of at least about 25° C. but below the softening point of the polymer. In the second treatment step, the polymer is then heated to a temperature of at least about 25° up to the softening point of the polymer, at an oxygen concentration that is within the same range as in the first treatment step. The total reaction time is typically about 0.5 hour to four hours. After the oxygen treatment, the polymer is treated at a temperature of at least about 80° C. but below the softening point of the polymer, typically for about 0.5 hour to about two hours, in an inert atmosphere such as nitrogen to quench any free radicals.

Suitable organic peroxides for this peroxygenated polyolefin production process include acyl peroxides, such as benzoyl and dibenzoyl peroxides; dialkyl and aralkyl peroxides, such as di-tert-butyl peroxide, dicumyl peroxide, and cumyl butyl peroxide; peroxy esters, such as tert-butylperoxy-2-ethylhexanoate; and peroxycarbonates, such as di(2-ethylhexyl)peroxy dicarbonate. The peroxides can be used neat or in diluent medium.

The typical peroxide concentration of the peroxygenated polyolefin material formed from these methods ranges from about 1 mmol to 200 mmol total peroxide per kilogram of polymer. The amount of total peroxide affects the melt flow rate of the product (i.e., polymers with a higher total peroxide content produce products with a higher MFR).

The metallic coupling agent of the present invention is at least one metallic salt of alpha, beta-unsaturated carboxylic acids or neutralized alpha, beta-unsaturated carboxylic acids (i.e., at least one of the H⁺ ions of the acid group has been replaced with a metal ion). The alpha, beta-unsaturated carboxylic acids or monocarboxylic acids preferably may be acrylic, methacrylic, maleic, fumaric, ethacrylic, vinyl-acrylic, itaconic, methyl itaconic, aconitic, methyl aconitic, crotonic, alpha-methylcrotonic, cinnamic, 2,4-dihydroxy cinnamic acids, or any combination thereof. Acrylic, methacrylic, and maleic acids, or combinations thereof, are more preferred, with acrylic or methacrylic acids being most preferred in one embodiment. Examples of metal ions that form the salts by neutralization of the alpha, beta-unsaturated carboxylic acids include lithium, sodium, potassium, cesium and other monovalent metals, magnesium, calcium, strontium, barium, copper, zinc and other divalent metals, and aluminum, iron and other trivalent metals, or any combination thereof. Divalent metals are preferred, and zinc is more preferred. The metals may be incorporated into the composition by using the metallic salts of the acrylic or methacrylic acids obtained by reacting a metal compound and the acrylic or methacrylic acid (e.g., zinc (di) acrylate or zinc (di) methacrylate) or by addition of the acrylic or methacrylic acid and a metal compound (i.e., metal oxide, metal hydroxide, metal carbonate, or the like) separately into the polyolefin blend and reacting them in the mixture to form the metallic salts of acrylic and methacrylic acids in situ. Generally, about 0.01 pph to 7 pph, preferably about 0.05 pph to 5 pph, and more preferably about 0.5 pph to 4 pph, of the metallic coupling agent is sufficient to facilitate increased melt strength in the semi-crystalline propylene.

Further optional, but preferable, components of the present invention include at least one substantially amorphous elastomer present in an amount of about 1 to 99 weight percent. Preferred elastomers may be an olefinic elastomer, a styrenic elastomer, or a mixture thereof. The substantially amorphous elastomeric component may be an olefinic elastomer with a weight average molecular weight (M_{w}) typically at least about 95,000, and preferably greater than about 100,000. In one embodiment, the M_{w} is greater than about 100,000 and no more than about 1,000,000, while in another embodiment the M_{w} is at least about 150,000 to about 700,000. The melt index of such high molecular weight elastomers can be difficult to measure, but may be less than about 5 dg/min, preferably less than about 1 dg/min. Melt index is inversely proportional to the molecular weight of the polymer. Thus, the higher the molecular weight, the lower the melt index, although the relationship is not linear. The density of the optional, but preferred, elastomer component is preferably from about 0.80 g/cm³ to 0.91 g/cm³.

The olefinic elastomeric component of the present invention preferably includes one or more ethylenic elastomers that each include copolymers of ethylene with at least one other monomer chosen from C₃ to C₂₀ alpha-olefins, unsaturated organic acids and their derivatives, vinyl esters, vinylsilanes and unconjugated aliphatic and monocyclic diolefins, alicyclic diolefins that have an endocyclic bridge and conjugated aliphatic diolefins, or terpolymers of ethylene, a C₃ to C₂₀ alpha-olefin, a nonconjugated diene monomer, or combinations thereof.

In the case of ethylene/alpha-olefin copolymers, the alpha-olefin includes one or more C₃ to C₂₀ alpha-olefins, with propylene, octene, butene, and hexene being preferred, and octene and butene being more preferred, for use in the substantially amorphous elastomeric component.

For elastomeric terpolymers, i.e., substantially amorphous elastomers with at least three comonomers, the alpha-olefin again can include one or more of C₃ to C₂₀ alpha-olefins with propylene, butene, and octene preferred and propylene being most preferred. These terpolymers typically include a diene component, which can include one or more of C₄ to C₂₀ dienes, preferably non-conjugated dienes. Examples of suitable non-conjugated dienes include 1,4-hexadiene; 1,6-octadiene; 5-methyl-1,4-hexadiene; 3,7-dimethyl-1,6-octadiene; 1,3-cyclopentadiene; dicyclopentadiene; 5-methylene-2-norbornene; 5-ethylidene-2-norbornene; 5-vinyl-2-norbornene; and combinations thereof. As used herein, the terms “non-conjugated diene” and “diene” are used interchangeably.

Exemplary olefinic elastomeric components are commercially available as NORDEL or ENGAGE from DuPont Dow Elastomers LLC of Wilmington, Del., as VISTALON or EXACT from ExxonMobil Chemicals of Houston, Tex., as DUTRAL from Polimeri Europa Americas of Houston, Tex., as BUNA EP from Bayer Corporation of Pittsburgh, Pa., and as ROYALENE from Crompton Corporation of Middlebury, Conn.

The substantially amorphous elastomeric component may also be a styrenic elastomer, which is a term used to designate an elastomer having at least one block segment of a styrenic monomer in combination with an olefinic component. The structure of the styrenic elastomer useful in the current invention can be of the linear or radial type, and preferably of the diblock or triblock type. The styrenic portion of the elastomer is preferably a polymer of styrene and its analogs and homologs, including alpha-methylstyrene, and ring-substituted styrenes, particularly ring-methylated styrenes. The preferred styrenics are styrene and alpha-methylstyrene, with styrene being especially preferred. The olefinic component of the styrenic elastomer may be ethylene, butylene, butadiene, isoprene, propylene, or a combination thereof.

Preferred styrenic elastomers include styrene-ethylene/butylene, styrene-ethylene/butylene-styrene, styrene-ethylene/propylene, styrene-ethylene/propylene-styrene, styrene-ethylene/propylene-styrene-ethylene-propylene, styrene-butadiene, styrene-butadiene-styrene, styrene-butylene-styrene, styrene-butylene-butadiene-styrene, styrene-isoprene-styrene, or combinations thereof.

Exemplary styrenic compatibilizers are commercially available as TUFTEC from Asahi America Inc. of Malden, Mass., as SEPTON from Kuraray Company, Ltd. of Tokyo, Japan, as KRATON from Kraton Polymers of Houston, Tex., or as DYNARON from Japan Synthetic Resin of Tokyo, Japan.

The substantially amorphous elastomeric component may be linear, substantially linear, random, blocky or branched, or a combination thereof. “Substantially amorphous,” as used herein, typically means that the elastomer has less than about 25 percent crystallinity, preferably less than about 20 percent crystallinity. An exemplary elastomer may have less than about 10 percent crystallinity.

A variety of conventional additives may also be optionally, but preferably, included in the compositions of the invention, including one or more thermal stabilizers, mineral fillers, ultraviolet stabilizers, antioxidants, foaming agents, waxes, flame retardants, dispersants, antistatic agents, lubricants, extender or process oils, nucleating agents, plasticizers, colorants, mold release agents, pigments, and the like, or combinations thereof.

Suitable mineral fillers include, but are not limited to, talc, ground calcium carbonate, precipitated calcium carbonate, precipitated silica, precipitated silicates, precipitated calcium silicates, pyrogenic silica, hydrated aluminum silicate, calcined aluminosilicate, clays, mica, wollastonite, and combinations thereof. When such optional mineral fillers are included, they can typically be present in amounts of about 1 to 40 weight percent, preferably in amounts of about 2 to 20 weight percent in one embodiment and in amounts of about 15 to 35 weight percent in another embodiment.

Techniques for reactive processing of a polymer with additives of all types are known to those of ordinary skill in the art and can typically be used with the present invention. Typically, in a reactive processing operation useful with the present invention, the individual components are combined in a mechanical extruder or mixer, and then heated to a temperature sufficient to form a polymer melt (i.e., above the melting point of polypropylene) and effect the reactive modification. In one embodiment, the blended components are heated to a temperature above about 150° C. and below about 300° C., preferably above about 160° C. and below about 250° C.

The mechanical mixer can be a continuous or batch mixer. Examples of suitable continuous mixers include single screw extruders, intermeshing co-rotating twin screw extruders such as Werner & Pfleiderer ZSK™ extruders, counter-rotating twin screw extruders such as those manufactured by Leistritz™, and reciprocating single screw kneaders such as Buss™ co-kneaders. Examples of suitable batch mixers include lateral 2-roll mixers such as Banbury™ or Boling™ mixers. The semi-crystalline polypropylene resin, the peroxygenated polyolefin, the metallic coupling agent, and the optional substantially amorphous elastomer are melt blended until the free radicals generated by the peroxygenated polyolefin are thermally decomposed and the metallic coupling agent is fully reacted. The temperature of the melt, residence time of the melt within the mixer and the mechanical design of the mixer are several variables that control the amount of shear to be applied to the composition during mixing and can be readily selected by one of ordinary skill in the art based on the disclosure of the invention herein.

In a preferred embodiment, the reactively blended propylene composition is prepared by mixing the semi-crystalline polypropylene resin, the peroxygenated polyolefin, and the metallic coupling agent in a Banbury™ mixer until the temperature of the polymer blend reaches 180° C. so that the free radicals generated by the peroxygenated polyolefin are thermally decomposed and metallic coupling agent is fully reacted. The material is then discharged. Other ingredients, such as fillers, thermal stabilizers, and the like, as described above, may be added to the mix either during the initial blending, downstream from the first feeder, or subsequently, when further processing is required.

The increased melt strength semi-crystalline polypropylene resin and optional substantially amorphous elastomer of the present invention may be pelletized, such as by strand pelleting or commercial underwater pelletization.

Pellets, granules, or other forms of the composition are then used to manufacture articles through conventional processing operations, such as thermoforming, that involve stretching and/or drawing. Similar industrial processes involving stretching and/or drawing include extrusion, blow molding, calendering or foam processing. In each of these processes, the melt strength of the polymer is critical to its success, since the melted and/or softened polymer must substantially retain its intended shape while being handled and/or cooled. During extrusion, for example, a plastic sheet extrusion system is fed by one or more extruders feeding a sheet extrusion die. The die is closely followed by a roll cooling system. The resulting partially cooled sheet is further cooled on a roller conveyor of finite length.

While a wide array of suitable articles can be manufactured in part or in whole with the reactively blended propylene composition, they are particularly suited to use in articles that are typically made from lower melt strength semi-crystalline propylene. Preferably, articles that can be manufactured from the current invention include interior automotive components, such as instrument panel skins and door panel skins; building materials, such as roofing membranes and thermal and sound insulation; packaging materials; electrical and electronics materials; and nonwoven fabrics and fibers.

The melt strength of a polymer is determined herein by a Gottfert™ Rheotens Melt Tension instrument Model 71.97, which measures the force in centi-Newtons (cN) required to pull a polymer melt strand from a capillary die at constant acceleration. In this test, a polymer melt strand extruded vertically downwards from a capillary die was drawn by rotating rollers whose velocity increased at a constant acceleration rate. The polymer melt being stretched typically undergoes uniaxial extension. The melt strength parameter does not give a well-defined rheological property because neither the strain, nor the temperature, was uniform in the polymer melt being stretched. The test is useful, however, in obtaining meaningful comparisons of the drawing behavior of different polymers. The measured force increases as the roller velocity is increased and then generally remains constant until the strand breaks. Melt strength tests were conducted by piston extrusion of polymer melt through a die 2 mm in diameter at a wall shear rate of 58 sec⁻¹, and at different melt temperatures, such as 190° C. and 230° C. A consistently improved melt strength over a broader range of temperatures is an indication of an increased processing window for the manufactured product.

Preferably, the reactively modified blend resins of the invention are at least substantially free, or entirely free, of organic peroxides before or after reaction thereof—except for any organic peroxides included or used in preparing the peroxygenated propylene component. In this context, “substantially free” means that less than about 0.1 pph, preferably less than about 0.01 pph, and more preferably, less than about 0.001 pph of an organic peroxide is present in the compositions of the invention. Preferably, the reactively blended propylene composition of the invention is at least substantially free, or entirely free, of crosslinking.

The term “about,” as used herein, should generally be understood to refer to both numbers in a range of numerals. Moreover, all numerical ranges herein should be understood to include each tenth of an integer within the range. Unless indicated to the contrary, all weight percents are relative to the weight of the total composition.

All of the patents and other publications recited herein are incorporated herein by express reference thereto.

### EXAMPLES

The invention is further defined by reference to the following examples, describing the preparation of some thermoplastic blends of the present invention. It will be apparent to those of ordinary skill in the art that many modifications, both to materials and methods, may be practiced without departing from the purpose and intent of this invention based on the description herein. Thus, the following examples are offered by way of illustration, and not by way of limitation, to describe in greater detail certain methods for the preparation, treatment, and testing of some thermoplastic blends of the invention.

The significance of the symbols used in these examples, the units expressing the variables mentioned, and the methods of measuring these variables, are explained below. The test specimens were prepared by injection molding using a Van Dorn 120HT Injection Molding Machine at a melt temperature of 200° C. and a mold cavity temperature of 18° C.

| | |
|---|---|
| Tensile strength | Ultimate tensile strength at 23° C., with crosshead |
| [MPa] | velocity of 500 mm/min, measured in mega Pascals, |
| | according to ASTM D-412-02 |
| Tensile Elongation | Tensile elongation percent at 23° C., with crosshead |
| [%] | velocity of 500 mm/min, according to ASTM |
| | D-412-02 |
| MFR [dg/min] | Melt flow rate measured at 190° C., under a load of |
| | 2.16 kg, according to ASTM D-1238-01 |
| Gloss, 60° | Specular gloss, measured at 60 degrees, according |
| | to ASTM D-2457-03 |
| F [cN] | Melt strength as determined by a Gottfert ™ |
| | Rheotens Melt Tension instrument Model 71.97 that |
| | measures the force (F) in centi-Newtons (cN) |
| | required to pull a polymer melt strand from a |
| | capillary die at constant acceleration at a |
| | temperature of at least 180° C. |
| Vmax [mm/s] | Velocity at which draw resonance or breakage |
| | occurs during the measurement of melt strength |
| | with a Gottfert ™ Rheotens Melt Tension |
| | instrument Model 71.97, defined as melt |
| | extensibility |
| % Difference in Melt Strength | $\frac{F ( cN ) at 190 ° C . - F ( cN ) at 230 ° C .}{F ( cN ) at 190 ° C .} \times 100$ |

Materials used in the examples:

| | |
|---|---|
| PP | Polypropylene copolymer; MFR: 0.27 dg/min at 230° C. and |
| | 2.16 kg weight; Mw = 479,333 |
| HMS-PP | Polypropylene homopolymer; MFR: 0.7 dg/min at 230° C. |
| | and 2.16 kg weight; Mw = 361,000 |
| Elastomer | Terpolymer of ethylene, alpha-olefin and diene monomer; |
| | Ethylene content 70%; Mooney 70 (ML 1 + 4, 125° C.) |
| | blended with copolymer of ethylene and C₃ to C₂₀ |
| | alpha-olefin(s); Density: 0.886 g/cm³; MI: 0.45 dg/min |
| POP | Peroxygenated polyolefin; MFR >1000 dg/min at 230° C. and |
| | 2.16 kg weight; peroxide content = 35 mmoles/kg |
| DBPH | Organic peroxide (DBPH) 2,5-dimethyl-2,5-di(t-peroxy)- |
| | hexane; Mw = 178.2; peroxide content = 687 mmoles/kg |
| Coupling | Acrylate metallic salt |
| agent | |
| Lubricant | Silicone masterbatch |

The examples shown below were prepared in a Leistritz 27 mm co-rotating twin screw laboratory extruder Model TSE-27 with a length to diameter ratio (L/D) of 52. The solid materials and any co-agent were pre-blended and added through the main feed throat while the lubricant, color concentrate and heat/light stabilizers, when used, were added downstream through a side feeder during the reactive extrusion. The extrusion temperature was 205° C., and the extruder speed was 400-450 rpm. Melt strength tests were conducted by piston extrusion of polymer melt through a die 2 mm in diameter at a piston speed to 2 mm/s, and at melt temperatures of 190° C. and 230° C.

The melt strength of pure, unblended polypropylene is difficult to measure with a Gottfert™ Rheotens instrument. For this reason, thermoplastic elastomer blends containing polypropylene resin are used in the examples as well as the comparative examples to provide a meaningful comparison. The surprising and unexpected presence of long chain branches on the modified semi-crystalline polypropylene resin of the invention is inferred by the increase in melt strength. The results also show that the modification of the propylene of the current invention increases the processing window during manufacturing, because the melt strength increase of the modified sample is achieved at a consistently high level over a broad range of temperatures. In other words, a low percentage difference in melt strength between the two temperatures (190° C. and 230° C.) is equivalent to a broad (and therefore more desirable) processing window for the manufacture of further materials using the inventive compositions. Thus, more consistent end products, such as extruded articles or molded articles, can be achieved with the compositions prepared according to the invention and these articles are also encompassed within the invention.

Examples 1-3 illustrate the surprising and unexpected improvement in melt strength of the modified polypropylene resin of the present invention. The polypropylene used for Comparative Example 1 is a commercially available high-melt-strength polypropylene that is shown to be sensitive to higher processing temperatures (i.e., the melt strength decreases with increasing temperature). Comparative Example 2 illustrates the surprising and unexpected result that the presence of the peroxygenated polyolefin alone is insufficient to improve the melt strength of the semi-crystalline polypropylene resin, thus showing that the presence of a metallic coupling agent is necessary in the current invention to achieve the surprising and unexpected results of increased melt strength, particularly over a range of temperatures. Comparative Examples 3-4 illustrate the unacceptably narrow processing window obtained from the use of an organic peroxide, particularly when the incorrect amount is metered into the formulation during manufacture.

TABLE I

| | | | | Comp. | Comp. | Comp. | |
|---|---|---|---|---|---|---|---|
| | Ex. 1 | Ex. 2 | Ex. 3 | Ex. 1 | Ex. 2 | Ex. 3 | Comp. Ex. 4 |
| PP, wt % | 25 | 25 | 25 | — | 25 | 25 | 25 |
| HMS-PP, wt % | — | — | — | 28 | — | — | — |
| Elastomer, wt % | 72 | 72 | 72 | 69 | 72 | 72 | 72 |
| Lubricant, wt % | 3 | 3 | 3 | 3 | 3 | 3 | 3 |
| POP, pph | 0.5 | 1 | 2 | — | 1 | — | — |
| DBPH, pph | — | — | — | — | — | 0.05 | 0.5 |
| Coupling agent, pph | 1.3 | 1.3 | 1.3 | — | — | 1.3 | 1.3 |
| Tensile strength [MPa] | 8.7 | 9.0 | 8.5 | 8.9 | 6.8 | 9.2 | 9.7 |
| Tensile elongation [%] | 495 | 485 | 484 | 607 | 770 | 508 | 693 |
| MFR [dg/min] | <1 | <1 | <1 | <1 | <1 | <1 | — |
| Gloss, 60° | 3.3 | 3.2 | 2.8 | 3.7 | 3.4 | 4.9 | 3.5 |
| F (cN), 190° C. | 23.0 | 21.9 | 18.3 | 12.8 | 12.4 | 24.8 | 16.2 |
| Vmax [mm/s], 190° C. | 63.2 | 69.1 | 64.4 | 87.8 | 87.9 | 74.7 | 73.3 |
| F (cN), 230° C. | 21.0 | 19.9 | 15.0 | 9.7 | 9.5 | 18.4 | 12.9 |
| Vmax [mm/s], 230° C. | 48.8 | 50.4 | 58.9 | 109.0 | 97.0 | 66 | 72.0 |
| % Difference in Melt | 8.7 | 9.1 | 18.0 | 24.2 | 23.4 | 25.8 | 20.4 |
| Strength | | | | | | | |

It is to be understood that the invention is not to be limited to the exact configuration as illustrated and described herein. Accordingly, all expedient modifications readily attainable by one of ordinary skill in the art from the disclosure set forth herein, or by routine experimentation therefrom, are deemed to be within the spirit and scope of the invention as defined by the appended claims.

What is claimed is:

1. A reactively blended propylene composition comprising the following, or a reaction product thereof:
a base polymer comprising at least one semi-crystalline polypropylene resin component;
at least one peroxygenated polyolefin component present in an amount greater than 0.05 pph of the base polymer; and
at least one metallic coupling agent present in an amount which, in combination with the peroxygenated component, is sufficient to provide increased melt strength to the reactively blended propylene composition compared to the semi-crystalline resin component.

2. The composition of claim 1, wherein the at least one peroxygenated polyolefin component is present in an amount from at least about 0.055 pph to 20 pph.

3. The composition of claim 1, wherein the at least one peroxygenated polyolefin component has a peroxide content ranging from about 1 mmol to 200 mmol total peroxide per kilogram of polyolefin.

4. The composition of claim 1, wherein the sufficient amount of metallic coupling agent is from about 0.01 pph to 7 pph of the base polymer.

5. The composition of claim 1, wherein the metallic coupling agent comprises one or more metal salts of alpha, beta-unsaturated carboxylic acids, or neutralized alpha, beta-unsaturated carboxylic acids, or mixtures thereof.

6. The composition of claim 5, wherein the alpha, beta-unsaturated carboxylic acids of the metallic coupling agent comprise one or more acrylic, methacrylic, maleic, fumaric, ethacrylic, vinyl-acrylic, itaconic, methyl itaconic, aconitic, methyl aconitic, crotonic, alpha-methylcrotonic, cinnamic, or 2,4-dihydroxy cinnamic acids, or mixtures thereof.

7. The composition of claim 6, wherein the alpha, beta-unsaturated carboxylic acids of the metallic coupling agent comprise one or more acrylic, methacrylic, or maleic acids, or mixtures thereof.

8. The composition of claim 5, wherein the metal ion for neutralizing the alpha, beta-unsaturated carboxylic acid comprises zinc, lithium, calcium, magnesium, sodium, aluminum, or a mixture thereof.

9. The composition of claim 1, wherein the base polymer further comprises one or more olefinic elastomers, styrenic elastomers, or a blend or mixture thereof.

10. The composition of claim 1, further comprising one or more thermal stabilizers, ultraviolet stabilizers, flame retardants, mineral fillers, extender or process oils, conductive fillers, nucleating agents, plasticizers, impact modifiers, colorants, mold release agents, lubricants, antistatic agents, pigments, or a combination thereof.

11. A molded article comprising the reactively blended propylene composition of claim 1.

12. An extruded article comprising the reactively blended propylene composition of claim 1.

13. A method for producing a reactively modified propylene composition which comprises:
blending a base polymer comprising at least one semi-crystalline polypropylene resin component with at least one peroxygenated polyolefin component present in an amount greater than 0.05 pph and at least one metallic coupling agent to form a reaction blend, with the at least one metallic coupling agent present in an amount which, in combination with the peroxygenated component, is sufficient to provide increased melt strength to the reactively modified propylene composition; and
reactively modifying the reaction blend to form a reactively modified propylene composition having increased melt strength compared to the semi-crystalline resin component.

14. The method of claim 13, which comprises providing the at least one peroxygenated polyolefin component in an amount from at least about 0.055 pph to 20 pph and providing the sufficient amount of metallic coupling agent in an amount from about 0.01 pph to 7 pph, so as to graft a portion of the peroxygenated polyolefin component to the semi-crystalline propylene resin.

15. The method of claim 13, which comprises providing the at least one peroxygenated polyolefin component having a peroxide content ranging from about 1 mmol to 200 mmol total peroxide per kilogram of polyolefin.

16. The method of claim 13, wherein the metallic coupling agent is selected to comprise one or more metal salts of alpha, beta-unsaturated carboxylic acids, or neutralized alpha, beta-unsaturated carboxylic acids, or mixtures thereof.

17. The method of claim 16, wherein the alpha, beta-unsaturated carboxylic acids of the metallic coupling agent is selected to comprise one or more acrylic, methacrylic, maleic, fumaric, ethacrylic, vinyl-acrylic, itaconic, methyl itaconic, aconitic, methyl aconitic, crotonic, alpha-methylcrotonic, cinnamic, or 2,4-dihydroxy cinnamic acids, or mixtures thereof.

18. The method of claim 16, wherein the alpha, beta-unsaturated carboxylic acid is neutralized by a metal ion comprising zinc, lithium, calcium, magnesium, sodium, aluminum, or a mixture thereof.

19. The method of claim 13, which further comprises molding the reactively modified propylene composition to form a molded article.

20. The method of claim 13, which further comprises extruding the reactively modified propylene composition to form an extruded article.

21. A method of imparting increased melt strength to a semi-crystalline propylene composition which comprises:
combining amounts of a peroxygenated polyolefin component and a metallic coupling agent with a base polymer comprising a semi-crystalline propylene composition to form a reaction blend; and
reacting the reaction blend to form a modified semi-crystalline propylene composition having long chain branches and a melt strength that is increased compared to the semi-crystalline propylene composition before reaction,
wherein the at least one metallic coupling agent is present in an amount which, in combination with the peroxygenated component, is sufficient to provide the increased melt strength to the reactively modified propylene composition.
